(19) United States
(12) Patent Application Publication
(10) Pub. No.: US 2007/0292626 A1
(43) Pub. Date: Dec. 20, 2007

(54) Apparatus and Method for Manufacturing and Surface Coating an Object

(75) Inventors: Owe Larsson, Hoeganaes (SE); Christer Hens, Helsingborg (SE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 10/588,350

(22) PCT Filed: Feb. 1, 2005
(86) PCT No.: PCT/EP05/00979

§ 371 Date: May 15, 2007

(30) Foreign Application Priority Data
Feb. 3, 2004 (EP) 04002346.7

(51) Int. Cl. B29C 37/00

(52) U.S. Cl. 427/424; 118/50

(57) ABSTRACT

A system and method for producing and coating an object that includes a manufacturing machine and an object treatment device is disclosed. The object treatment device includes a painting station for applying a coating to a surface of the object, at least an other station for treating the object, and a tape conveyor belt for moving the object between the stations. The object treatment device is provided with an enclosure with a controlled atmosphere within the enclosure. The manufacturing machine is located outside the enclosure.

### BACKGROUND AND SUMMARY OF THE INVENTION

This application claims the priority of International Application No. PCT/EP2005/000979, filed Feb. 1, 2005, and European Patent Document No. EP 04002346.7, filed Feb. 3, 2004, the disclosures of which are expressly incorporated by reference herein.

The invention relates to a system for producing and coating an object, comprising a manufacturing machine and an object treatment device wherein the object treatment device comprises a painting station with means for applying a coating to a surface of the object, at least another station for treating the object and a conveyor which allows for movement of the object between the stations. Further the invention relates to a method for producing and coating a molded object, comprising the steps of producing the object in a manufacturing machine, moving the object to an object treating device, which comprises a painting station and at least an other station for treating the object, applying a coating to a surface of the object in the painting station and moving the object from the painting station to the other station.

Plastic parts or objects are typically manufactured in several steps. The first step comprises molding of the plastic object by any known plastic injection method, the second step comprises lacquering of the object by any generally known method, the third step comprises any generally known printing method.

The plastic objects are conventionally lacquered in an open spray system, a dip system, Inmould labelling or Inmould Decoration Moulding system. These systems are open to the atmosphere. During the spray lacquering process, over-spray of paint occurs. Such over-spray of paint constitutes an environmental problem and thus additional equipment is necessary to prevent the atmosphere, as well as to keep the system itself clean, from over-sprayed paint.

In International Publication No. WO 03/049929 a single tool for injection molding as well as painting of an object is disclosed. In an injection molding station the object is molded between a turnable mold part and a stationary mold part. The turnable mold part with the object is rotated 90 degrees to another station where paint is applied to the object, with the object still placed on the turnable mold part. In additional stations the paint applied to the object is UV hardened and then the object is ejected from the turnable mold part. Finally the turnable mold part is rotated back to the injection molding station to start the cycle again.

The advantage of that system is that there is only one machine for the production and painting of the plastic object without the need to transport the object from an injection molding machine to a painting machine. However, the injection molding step is essentially faster than the painting and hardening step. Thus by using such a combined injection molding and painting machine the cycle time is increased and the productivity reduced. Further the turnable mold part might be contaminated with paint and thus has to be cleaned from time to time in order to avoid damaging of the objects during the injection molding step.

It is an object of the invention to provide a system and a method to apply a coating to an injection molded object with a high productivity, high yield but reduced manufacturing costs. Further the environmental problems and hazards shall be minimized. Further the quality of the coating shall be increased, in particular with respect to wear resistance and cosmetic and optical aspects.

This object is achieved by a system for producing and coating an object, comprising a manufacturing machine and an object treatment device wherein the object treatment device comprises a painting station with means for applying a coating to a surface of the object, at least another station for treating the object and a conveyor which allows for moving the object between the stations, which is characterized in that the object treatment device is located within an enclosure comprising means to create a controlled atmosphere within the enclosure and wherein the manufacturing machine is located outside the enclosure.

The inventive method for producing and coating a molded object comprises the steps of:
producing the object in a manufacturing machine,
moving the object to an object treating device, which comprises a painting station and at least an other station for treating the object,
applying a coating to a surface of the object in the painting station,
moving the object from the painting station to the other station
   wherein
   the object treating device is located within an enclosure and the object is coated and treated in a controlled atmosphere and the manufacturing step is performed outside the enclosure.

The invention relates in particular to the manufacturing of plastic objects. Preferably the objects are produced in an injection molding machine, an extrusion molding machine, a rolling mill, or a metal pouring machine.

The object treating device according to the invention is integrated to the manufacturing machine of the object or free standing from the manufacturing machine. In any case the manufacturing of the object is carried out outside of the enclosure which encapsulates the object treating device and its different stations. Preferably the manufacturing process is not directly coupled to the subsequent coating and treatment steps. That means that neither the manufacturing step nor the coating/treatment step is limited by the other step.

It has been found that most of the rejects are due to the handling of the objects in free atmosphere, due to logistic processes, and due to contamination into the different stations. Thus according to the invention the object treating device is provided with an enclosure and at least after the manufacturing step the object is treated in a controlled atmosphere.

Further, the invention implies that one or more manufacturing machines can feed the surface coating device with one or several different designed objects. Preferably, the object treating device is moveable and can be transported to different sources of manufacturing and/or places.

The wear resistance of the object is preferably increased by UV curing in a controlled atmosphere. Further, the lacquer formula and its quality conditions influence the wear resistance. Wear resistance is related to hardness and, according to the invention, it is possible to achieve a hardness above pencil hardness of 8.0 or higher. The controlled gas atmosphere further influences lacquer performances such as surface hardness, brittleness and cosmetic aspects concerning the object.

Preferably the object is coated and treated in an atmosphere with a total dust content of less than 1000 particles above 15 micron per cubic foot, more preferably less than 150 particles per cubic foot.

Preferably the object is put into clean room conditions directly after its manufacturing and held under clean room conditions during the transfer to the object treating device. For example the objects may be charged into a cassette which itself is then placed into a clean room atmosphere. The number of objects that must be discarded due to damage is thereby considerably reduced.

In a preferred embodiment the objects are packed and transferred as well as treated in the several stations of the object treating device without any manual handling. Unloading the objects from the manufacturing machine, transfer to the object treating device, treating within the object treating device as well as removing the objects from the object treating device and final packing of the objects are carried out automatically.

According to the invention the objects are moved between the different stations of the treating device by a conveyor, which preferably comprises a conveyor belt or a turnable tool. Thus the atmosphere within the object treating device is kept free from contamination during positioning of the object. Conventionally tools or ordinary conveyors may be contaminated by lacquer and thereby dust problems may occur. Thus the conveyor belt is preferably an article of consumption and disposed of after use. The conveyor belt is preferably made of PET and/or PE based material.

In particular when UV radiation is used to harden the coating applied to the object it is advantageous to provide an atmosphere having a low oxygen content, preferably less than 500 ppm, more preferably less than 180 ppm. The importance of low oxygen content in the environment is to make use of the photoinitiator concentration in the lacquer and/or to combine a certain lacquer with a certain concentration of photoinitiators to a certain UV-radiation and oxygen content. Thus, it is possible to get after the UV-cure objects with exactly the same performances and hardness.

According to the invention a controlled atmosphere is produced within the enclosure. The controlled atmosphere may be an atmosphere of pre-cleaned air or, preferably, an inert gas atmosphere. In some cases it is further advantageous to have different atmospheres in different stations within the enclosure. For example it is often sufficient to have an atmosphere of clean air within the loading and unloading station of the object treating device, whereas it is preferred to have an inert gas atmosphere in the painting station and the UV curing station. Thus, it is advantageous to provide one or more of the different stations with an additional enclosure. Thus it is possible to have different atmospheres in different treating steps whereas the transport from one station to another station occurs within the enclosure covering the whole object treating device.

The station where the coating is applied to the object is preferably equipped with a supply equipment of lacquer, paint, or any other substance which the object is to be coated with. Within this description the expressions “lacquer”, “paint” and “coating” are used synonymously.

In a preferred embodiment the lacquer is driven from the lacquer supply to a spray head with gas, preferably nitrogen or carbon dioxide, and then sprayed by the spray head to the object. The nitrogen or carbon dioxide shall have a sufficient purity, preferably 99.996% or higher. Preferably, the lacquer pressure after atomization shall be below 1 bar or even below 0.5 bar (relative to the pressure in the painting station) in order to propel and spray the lacquer and to coat the object in a very precise manner. The gas atomizes the lacquer into droplets. Thus small volumes of lacquer can be applied to the object, preferably 0.001 to 0.005 gram per square cm. These circumstances allow it to provide the painting station with an enclosure of well-defined volume, preferable below 30 liters. Within that volume well-controlled laminar flows are achieved and thereby an extremely low overspray can be obtained.

In a preferred embodiment the spray head or the spray gun is movable. The movement of the spray head is designed according to the geometry of the object. That movement of the spray head allows for providing large surfaces and/or more objects with an even coating of equal thickness. The moveability of the spray gun or the spray head allows for following two-dimensional and three-dimensional object surfaces and shapes. In particular the lacquering of three-dimensional surfaces is essentially improved. Further by moving the spray head according to the dimensions of the object any over-spraying is minimized, that is the volume of lacquer which is not applied to the object is reduced.

To prevent contamination of the painting station itself it is advantageous to provide the object with a metallic adapter with an interface design according to the geometry of the object or of parts of the object. The object is masked by that adapter and only those parts of the object which are to be coated are sprayed with the lacquer. The movement of the spray head is preferably carried out by mechanical and/or pneumatic arrangements.

The controlled atmosphere within the painting station and the controlled flow of lacquer assures that the lacquer is applied precisely where it is desired. Any over spray of lacquer is reduced and with regards to solvents and lacquer full environmental control is achieved.

In a preferred embodiment the object to be coated is placed onto a tape conveyor belt. That design of transportation allows a coating of different geometries simultaneously and implies that more than one geometry can be coated. The conveyor belt is controlled and programmed to different stations of the object treating device. The object treating device may thus be used for treating objects of different design and geometry.

In an alternative embodiment, the object to be coated is placed into a holder on a turnable tool. The turnable tool is controlled and programmed to different stations of the coating device. It is preferred to provide the turnable tool with interchangeable holders. The coating device may thus be used for treating objects of different design and geometry. The holder is preferably designed to hold between 4 and 8 objects which then can be coated and treated at the same time.

In addition to the painting station the coating device preferably comprises a UV treatment station with a UV radiation source. The UV treatment station where UV-curing occurs is equipped with an UV-source and cold mirrors to reflect the UV-rays. The UV-light equipment is encapsulated. The UV-rays are emitted to the object into an environment where the content of oxygen is extremely low. The UV treatment station is equipped with a oxygen monitoring system. The importance of low oxygen content in the environment is to make use of the photoinitiator concentration in the lacquer. The controlled gas atmosphere influences on lacquer performances such as surface hardness, brittleness and cosmetic aspects concerning the object.

The design of the UV treatment unit is controlled in a way such that several different objects can be treated at the same time and show equal performances regarding hardness and wear resistance.

It is further advantageous to use an IR station in order to influence the surface of the object before and/or after lacquering.

According to another embodiment the object treating device comprises a printing station where at least one surface of the object can be printed. The printing station is in particular designed and equipped with tampo-printing equipment.

According to another embodiment the object treating device further comprises a milling device, programmed according to the different design of objects. The milling device will make different milling tasks/designs according to requirements. One example is to make edges into a lens or into a display window. An other example is to make holes for knobs mounted in a later step.

The invention is in particular useful in the production and coating of plastic or metal objects, integrated or non-integrated parts such as lenses, display glasses, lamps, protection glasses, watches, home electronics, consumer electronic goods and medical equipment.

### BRIEF DESCRIPTION OF THE DRAWINGS

The invention as well as further details and preferred embodiments of the invention are disclosed in the following description and illustrated in the accompanying drawings, in which:

FIG. 1 schematically shows a coating device according to the invention;

FIG. 2 illustrates a cassette to carry the objects to be coated;

FIG. 3 illustrates details of the painting station and the UV treatment station; and

FIG. 4 shows an alternative embodiment according to the invention.

### DETAILED DESCRIPTION OF THE DRAWINGS

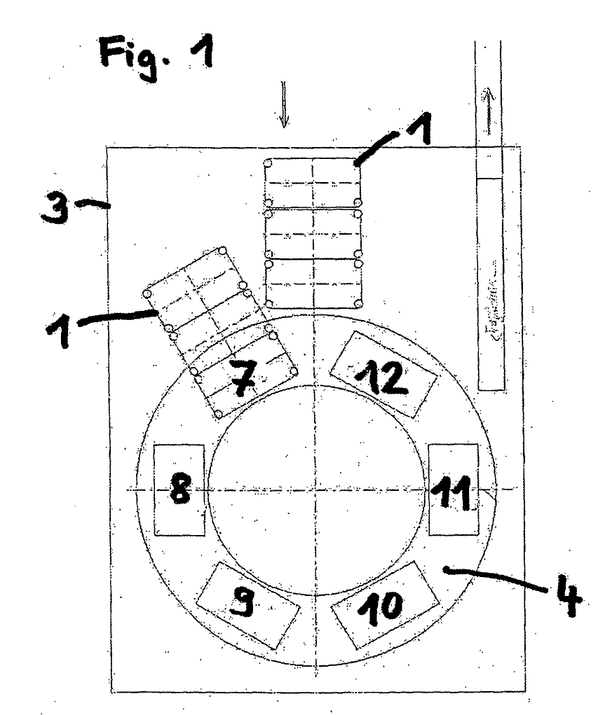

FIG. 1 shows a device according to the invention which is used to lacquer a display window for a mobile telephone or another consumer electronic product. In such parts it is known to provide the surface of some of the plastics parts with a layer of lacquer.

The lacquer may be applied for aesthetical and/or protective reasons. For example, a raw plastics surface may be given an improved appearance by treating it with lacquer, and a plastics component may be given improved resistance to wear and chemicals by providing a protective layer of lacquer on the surface thereof. Another example of the above-mentioned treatment is front lights for automotives where glasses are replaced by polycarbonate. These glasses shall as well have an optical performance. Other examples are display glasses for mobile telephones.

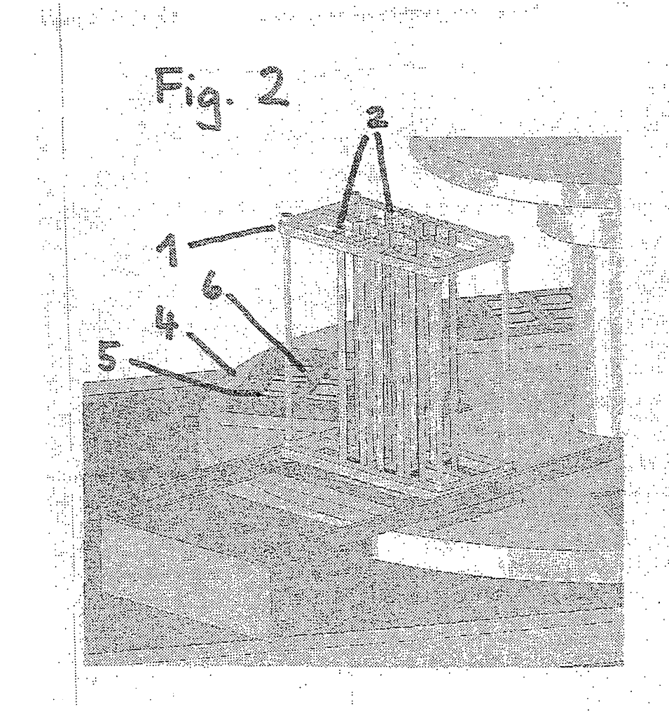

In the first step the object is manufactured in a conventional plastic injection molding machine or in a metal pouring machine. The whole equipment is placed in a clean room atmosphere. The object is charged from the injection machine into a cassette (1) (see FIG. 2). The cassette (1) will be charged with several objects. The cassette (1) is designed with flexible ribs (2) where objects of different dimensions can be charged. The ribs (2) grant no movement of the objects during the handling and transport.

The cassette (1) is packed in a box, all still in the clean room atmosphere to avoid dust and damages. The box in which the cassette (1) is packed has an overpressure of inert gas or filtered air before packaging to ensure that it is free from dust and particles.

The box with the cassettes (1) is then transported to the inventive coating device.

The coating device comprises an enveloped and air/gastight room (3). Into that room (3) a turnable disc (4) or conveyor or other fitment equipment for object holders (5) is mounted. Into the holders (5) the objects (6) are placed. By means of the turnable disc (4) the objects (6) are turned into the different stations (7, 8, 9, 10, 11, 12), which are all mounted in the enveloped and air/gastight room (3).

The air/gastight room (3) is a clean room area where filtered air (13) is blown into the room (3) through a Hepa filter (13) which is classified 50 000.

In the first step of operation—in loading station (7)—a cassette (1) with the objects (6) is moved into the clean room area (3) and automatically positioned at the turnable disc (4). Four objects (6) are discharged at the same time from the cassette (1) and placed into the object holders (5).

In the next station (8) the objects (6) are heated by infrared radiation to a certain temperature requested for the subsequent lacquering process. Before entering the lacquering process an antistatic treatment occurs, too.

In the painting station (8) a layer of lacquer is applied on selected areas of the object (6). The lacquer is atomized (15) by an inert gas (16), carbon dioxide or nitrogen. The lacquer is sprayed or applied by a precision application method and low pressure to avoid turbulence in stream.

The lacquer is preferably a UV-curable lacquer that is cured by exposing the lacquer to UV-light emitted from a UV-lamp (17) in UV treatment station (9). The UV lamp (17) is located in an encapsulated room (18) which is provided with an atmosphere with low oxygen content. This is established by feeding (19) an inert gas, such as nitrogen or carbon dioxide, into the encapsulated room (18) in order to achieve a gas-stabilized environment. The atmosphere influences the performances of the lacquer, for example the wear resistance in form of hardness and brittleness.

The inventive coating device is further equipped with process stations (10, 11) where deflashing and printing/lacquering occur. The printing is carried out in a conventional tampo print unit based on a conventional lacquer method cured by infrared radiation or UV-curable lacquer that is cured by exposing the lacquer to UV-light.

Printing station (11) is designed that printing/lacquering will occur on both sides of the object (6) in the same operation. The object holder (5) is a kind of frame which holds the object (6) at its edges. Thus the top and the bottom side of the object (6) can be printed simultaneously.

Finally turnable disc (4) is rotated to position the objects (6) in reloading station (12) where the objects (6) are automatically discharged from the holders (5).

The example described shows a surface coating (8), hardening (9), printing (11) dissembling and packaging procedure. For the man skilled in the art additional process stations can be added to the coating device. For example an assembling station may be included for assembling other material to the coated and treated objects (6). For example windows for mobile phones are coated, UV hardened and printed as described above and then assembled with covers for mobile phones which are also introduced into the assembling station of the device.

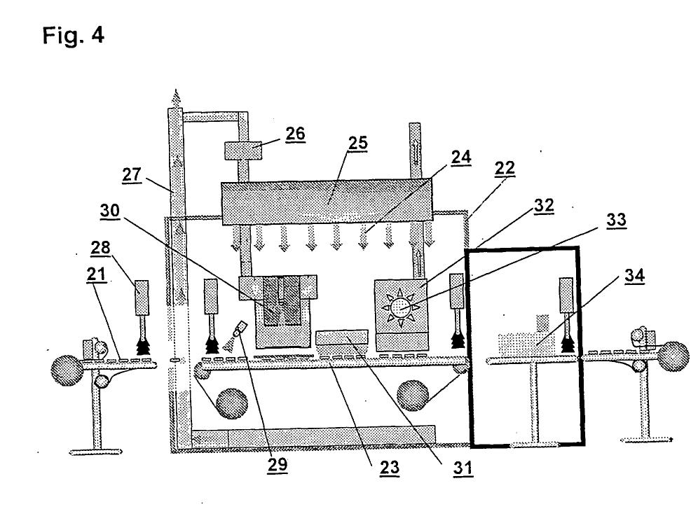

FIG. 4 shows an alternative embodiment according to the invention which is also used to lacquer display windows for mobile telephones or other consumer electronic products as explained above.

First the object (21) is produced in a conventional manner, for example in a plastic injection molding machine or in a metal pouring machine (not shown in the Figure). The whole equipment is placed in a clean room atmosphere. The object (21) is then transported to the inventive object treating device. During that transport the object may be packed into a cassette where a clean room atmosphere is obtained. The object can as well be transported to the coating device packed as tape on reel. Further the manufacturing machine can be integrated directly to the object treating device.

The object treating device comprises an enveloped room (22). Into that room (22) a tape conveyor or conveyor belt (23) is mounted where the object (21) is placed on. By means of the tape conveyor (23) the objects (21) are transported to the different stations (29, 30, 31, 32), which are all mounted in the enveloped room (22).

The enveloped room (22) is a clean room area where filtered air (24) is blown into the room (22) through a Hepa filter (25). The exhaust air and contamination are evacuated by a system (26, 27) equipped with metal and carbon filters.

In loading station (28) the objects (21) are moved into the clean room area (22) and automatically positioned at the tape conveyor belt (23).

As explained in connection with FIGS. 1 to 3, in the next station (29) the objects (21) are treated by ionized air, heated by infrared radiation to a certain temperature and surface conditions and an antistatic treatment occurs.

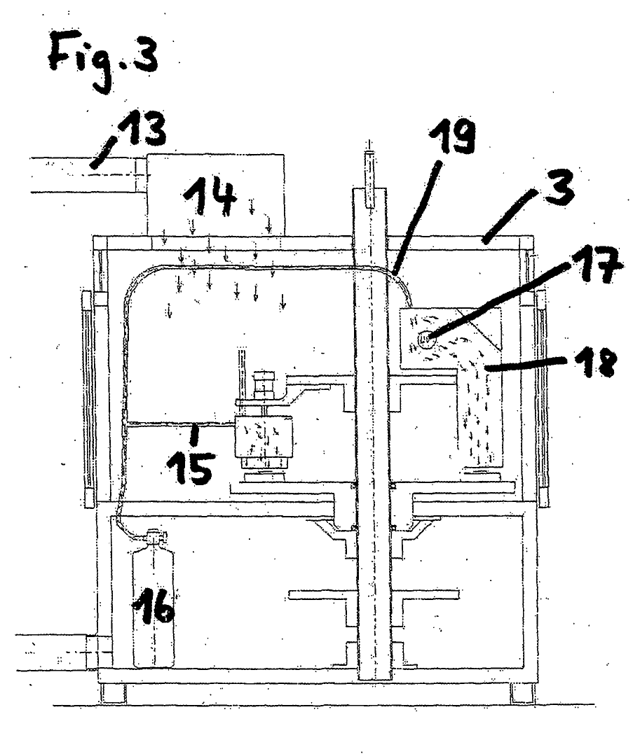

Painting station (30) is essentially designed as painting station (8) shown in FIG. 3. The painting is carried out in a controlled atmosphere by a low pressure spraying system. Thus minimal over spray is achieved.

The lacquer on the surface of the object is then stabilized by IR-unit (31). The IR-heating secures cosmetic aspects and forces up the degassing of solvents out of the lacquer.

In the next step the lacquered object is transported to a UV curing unit (32) with a UV-lamp (33) similar to UV treatment station (10) shown in FIGS. 1 to 3.

The inventive object treating device is further be equipped with enveloped process stations for printing and milling (34). The milling is carried out in a high speed milling unit served by a program according to the different geometries of the object. The printing station is not shown in the Figure.

The finished objects (21) are finally removed from the clean room area (22).

1-15. (canceled)

16. A system for producing and coating an object, comprising a manufacturing machine and an object treatment device wherein the object treatment device comprises a painting station with means for applying a coating to a surface of the object, at least an other station for treating the object, and a conveyor for moving the object between the stations, wherein the object treatment device is located within an enclosure and includes means for creating a controlled atmosphere within the enclosure, wherein the manufacturing machine is located outside the enclosure, and further wherein the object treatment device includes means for applying 0.001 to 0.005 gram per square cm of a lacquer to the surface of the object at a lacquer pressure below 1 bar.

17. The system according to claim 16, wherein the manufacturing machine is an injection molding machine, an extrusion molding machine, a rolling mill, or a metal pouring machine.

18. The system according to claim 16, wherein the conveyor comprises a conveyor belt or a turnable tool.

19. The system according to claim 16, wherein the means for applying a coating to a surface of the object comprises a movable spray head.

20. The system according to claim 16, wherein the object treating device further comprises at least one of a UV treatment station with a UV radiation source, a milling station, a printing station and an assembling station.

21. The system according to claim 16, wherein the means for applying a coating to a surface of the object comprises a spray gun, a tampo-printer, or a transducer.

22. A method for producing and coating an object, comprising the steps of:
producing the object in a manufacturing machine;
moving the object to an object treatment device, which comprises a painting station and at least an other station for treating the object;
coating a surface of the object with 0.001 to 0.005 gram per square cm of a lacquer in the painting station; and
moving the object from the painting station to the other station;
wherein the object treatment device is located within an enclosure, wherein the object is coated and treated in a controlled atmosphere, wherein the producing step is performed outside the enclosure, and wherein a lacquer pressure is below 1 bar.

23. The method according to claim 22, wherein the object is produced by injection molding, extrusion molding, rolling mill, or by metal pouring.

24. The method according to claim 22, wherein the coated object is UV treated in an inert gas atmosphere.

25. The method according to claim 22, wherein the object is coated and treated in an atmosphere with a total dust content of less than 1000 particles above 0.5 micron per cubic foot.

26. The method according to claim 22, wherein at least one of the steps of coating and treating the object is performed in an atmosphere having a low and controlled oxygen content of less than 500 ppm.

27. The method according to claim 22, wherein the object is provided with a mask prior to the coating step.

28. The method according to claim 22, wherein in the coating step lacquer or paint is atomized with an inert gas and sprayed to the object.

29. The method according to claim 22, wherein the object is moved from the painting station to the other station by a conveyor comprising a conveyor belt or a turnable tool.

30. The method according to claim 22, wherein the object has a different geometrical shape from an other object moved from the painting station to the other station.

31. A system for manufacturing and coating an object, comprising:
a manufacturing machine; and
an object treatment device, wherein the object treatment device includes a painting station, a second station, and a conveyor which moves the object between the painting station and the second station;
wherein the object treatment device is disposed within an atmosphere-controlled enclosure and wherein the manufacturing machine is located outside the atmosphere-controlled enclosure;
and further wherein the painting station applies 0.001 to 0.005 gram per square cm of a lacquer to a surface of the object at a lacquer pressure below 1 bar.

32. The system according to claim 31, wherein the second station is a UV treatment station.

33. The system according to claim 31, wherein the atmosphere-controlled enclosure includes a first enclosure with a first controlled atmosphere and a second enclosure with a second controlled atmosphere, and wherein the painting station is disposed within the first enclosure and wherein the second station is disposed within the second enclosure.

34. A method for manufacturing and coating an object, comprising the steps of:
manufacturing the object in a manufacturing machine;
moving the object to an object treatment device, wherein the object treatment device includes a painting station and a treating station;
coating a surface of the object with 0.001 to 0.005 gram per square cm of a lacquer in the painting station at a lacquer pressure below 1 bar; and
moving the object from the painting station to the treating station;
wherein the object treatment device is disposed within an atmosphere-controlled enclosure and the manufacturing machine is located outside the atmosphere-controlled enclosure.

35. The method according to claim 34, further comprising the step of UV curing the object in the treating station.
